(19) United States
(12) Patent Application Publication
(10) Pub. No.: US 2016/0309976 A1
(43) Pub. Date: Oct. 27, 2016

(54) Scraping Assembly

(71) Applicant: Nakhonphet Bouphanouvong, Kansas City, MO (US)

(72) Inventor: Nakhonphet Bouphanouvong, Kansas City, MO (US)

(21) Appl. No.: 14/692,806

(22) Filed: Apr. 22, 2015

(51) Int. Cl. A47L 13/08; B26B 5/00

(52) U.S. Cl. CPC A47L 13/08; B26B 5/00

(57) ABSTRACT

A scraping assembly includes a handle has a first end, a second end and a bottom side extending between the first end and the second end. The handle is elongated between the first end and the second end. A pair of grips is provided and each of the grips is attached to the handle wherein the grips may be gripped. A scraper is removably attached to the handle. The scraper is positioned on the second end wherein the scraper may be positioned to scrape a support surface. The scraper has a pair of cutting surfaces such that a selected one of the cutting surfaces is exposed on the second end.

### BACKGROUND OF THE DISCLOSURE

1. Field of the Disclosure

The disclosure relates to scraping devices and more particularly pertains to a new scraping device for scraping a support surface thereby facilitating the support surface to be refinished.

2. Summary of the Disclosure

An embodiment of the disclosure meets the needs presented above by generally comprising a handle has a first end, a second end and a bottom side extending between the first end and the second end. The handle is elongated between the first end and the second end. A pair of grips is provided and each of the grips is attached to the handle wherein the grips may be gripped. A scraper is removably attached to the handle. The scraper is positioned on the second end wherein the scraper may be positioned to scrape a support surface. The scraper has a pair of cutting surfaces such that a selected one of the cutting surfaces is exposed on the second end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a scraping assembly according to an embodiment of the disclosure.

FIG. 2 is a bottom perspective view of an embodiment of the disclosure.

FIG. 3 is a bottom view of an embodiment of the disclosure.

FIG. 4 is a right side view of an embodiment of the disclosure.

FIG. 5 is an exploded perspective view of an embodiment of the disclosure.

### DESCRIPTION OF THE PREFERRED EMBODIMENT

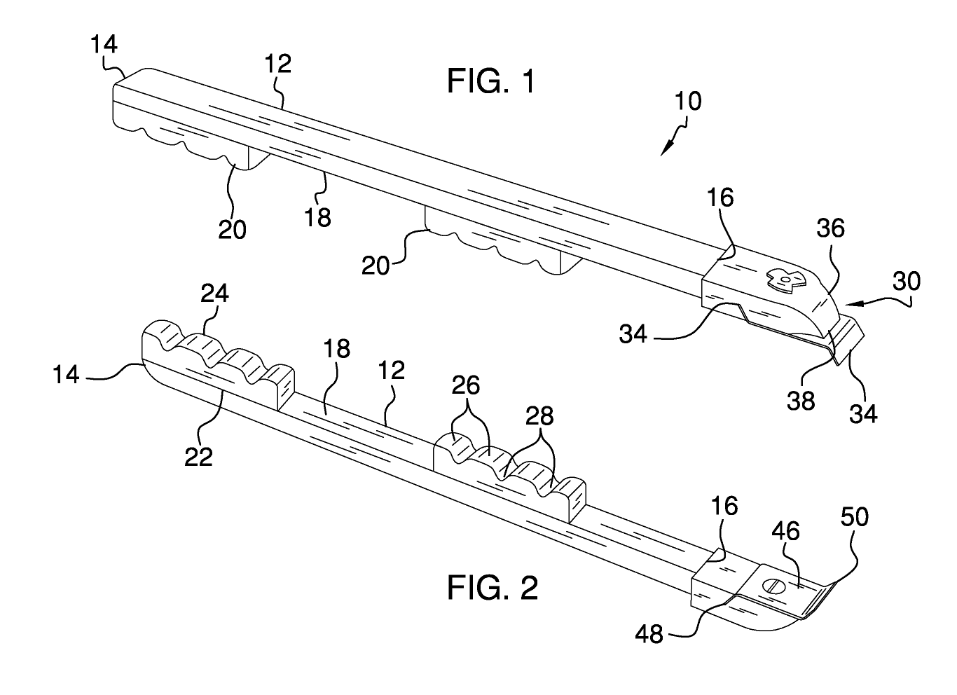

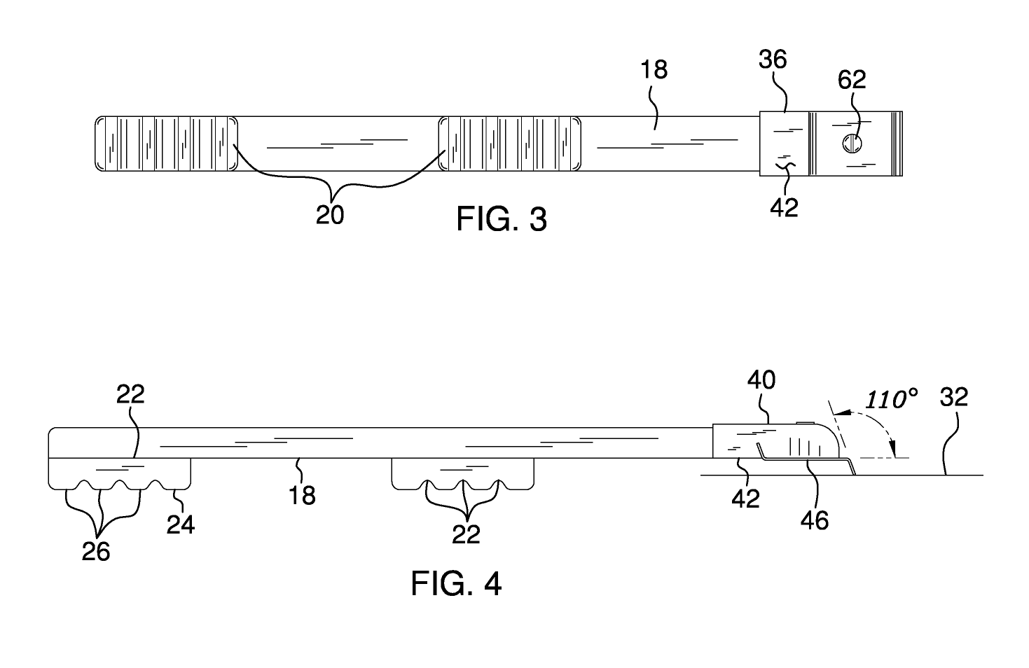

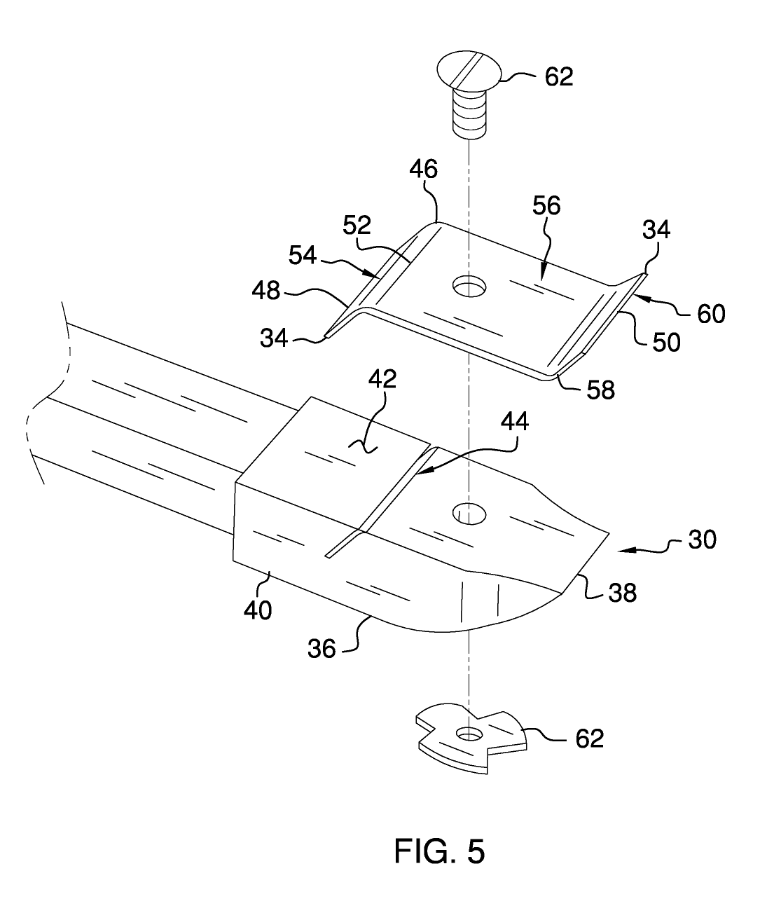

With reference now to the drawings, and in particular to FIGS. 1 through 5 thereof, a new scraping device embodying the principles and concepts of an embodiment of the disclosure and generally designated by the reference numeral 10 will be described.

As best illustrated in FIGS. 1 through 5, the scraping assembly 10 generally comprises a handle 12 that has a first end 14, a second end 16 and a bottom side 18 extending between the first end 14 and the second end 16. The handle 12 is elongated between the first end 14 and the second end 16. A pair of grips 20 is provided and each of the grips 20 has an upper side 22 and a lower side 24. Each of the grips 20 is attached to the handle 12 such that the grips 20 may be gripped and the upper side 22 is positioned to abut the bottom side 18. One of the grips 20 is positioned adjacent to the first end 14 and one of the grips 20 is positioned between the first end 14 and the second end 16. The lower side 24 of each of the grips 20 comprises an alternating sequence of hills 26 and valleys 28 and the hills 26 and valleys 28 are distributed along each of the grips 20. Thus, the hills 26 and valleys 28 enhance a grip of each of the grips 20. Each of the grips 20 may be comprised of a resiliently compressible material.

A scraper 30 is removably attached to the handle 12. The scraper 30 is positioned on the second end 16 wherein the scraper 30 may be positioned to scrape a support surface 32. The support surface 32 may be a hardwood floor or the like and the scraper 30 may be utilized to smooth the support surface 32 thereby facilitating the support surface 32 to be refinished. The scraper 30 has a pair of cutting surfaces 34 such that a selected one of the cutting surfaces 34 is exposed on the second end 16.

The scraper 30 comprises a mount 36 that is attached to and extends away from the second end 16. The mount 36 has a distal end 38 with respect to the second end 16 and the mount 36 has a top surface 40 and a bottom surface 42. The top surface 40 curves downwardly to meet the bottom surface 42 at the distal end 38. The bottom surface 42 has a slot 44 extending toward the top surface 40. The slot 44 is positioned closer to the second end 16 than the distal end 38 and the slot 44 extends laterally across the mount 36.

A blade 46 is provided that has a first end 48 and a second end 50 and each of the first end 48 and the second end 50 of the blade 46 is sharpened thereby defining each of the cutting surfaces 34. The blade 46 has a first bend 52 that is positioned proximate the first end 48 of the blade 46 to define a first portion 54 forming and angle with a central portion 56. The blade 46 has a second bend 58 that is positioned proximate the second end 50 of the blade 46 to define a second portion 60 forming an angle with the central portion 56 such that the first portion 54 is congruent with the second portion 60. The angle between each of the first portion 54 and the second portion 60 with respect to the central portion 56 may be an inside angle ranging between approximately 100° and 110°.

The blade 46 is removably attached to the bottom surface 42 having a selected one of the first portion 54 or the second portion 60 extending into the slot 44. Thus, a selected one of the first portion 54 or the second portion 60 extends downwardly from the bottom surface 42 such that a selected one of the first end 48 and the second end 50 may scrape the support surface 32. A fastener 62 extends through the blade 46 and engages the mount 36 such that the blade 46 is removably retained on the mount 36. The fastener 62 may comprise a nut and a bolt or the like.

In use, the blade 46 is attached to the mount 36 having a selected one of the first portion 54 or the second portion 60 being positioned within the slot 44. Each of the grips 20 is gripped and the handle 12 is manipulated to position the blade 46 against the support surface 32. The handle 12 is urged forwardly and rearwardly such that the blade 46 abrades the support surface 32 thereby facilitating the blade 46 to smooth the support surface 32. The angle of the first portion 54 and the second portion 60 combined with the orientation of the grips 20 provides a mechanical advantage when scraping the support surface 32 thereby reducing fatigue when the support surface 32 is scraped.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scraping assembly configured to scrape a surface thereby facilitating the surface to be smoothed, said assembly comprising:
a handle having a first end, a second end and a bottom side extending between said first end and said second end, said handle being elongated between said first end and said second end;
a pair of grips, each of said grips being attached to said handle wherein said grips are configured to be gripped; and
a scraper being removably attached to said handle, said scraper being positioned on said second end wherein said scraper is configured to be positioned to scrape a support surface, said scraper having a pair of cutting surfaces such that a selected one of said cutting surfaces is exposed on said second end.

2. The assembly according to claim 1, wherein each of said grips has an upper side and a lower side, said upper side being positioned to abut said bottom side, one of said grips being positioned adjacent to said first end, one of said grips being positioned between said first end and said second end.

3. The assembly according to claim 2, wherein said lower side of each of said grips comprising an alternating sequence of hills and valleys, said hills and valleys being distributed along each of said grips wherein said hills and valleys are configured to enhance a grip of each of said grips.

4. The assembly according to claim 1, wherein said scraper comprises a mount being attached to and extending away from said second end, said mount having a distal end with respect to said second end, said mount having a top surface and a bottom surface, said top surface curving downwardly to meet said bottom surface at said distal end, said bottom surface having a slot extending toward said top surface.

5. The assembly according to claim 1, further comprising a blade having a first end and a second end, each of said first end and said second end being sharpened, said blade having a first bend being positioned proximate said first end to define a first portion forming and angle with a central portion, said blade having a second bend being positioned proximate said second end to define a second portion forming an angle with said central portion such that said first portion is congruent with said second portion.

6. The assembly according to claim 5, wherein:
said scraper comprises a mount, said mount having a bottom surface, said bottom surface having a slot; and
said blade is removably attached to said bottom surface having a selected one of said first portion or said second portion extending into said slot such that a selected one of said first portion or said second portion extends downwardly from said bottom surface wherein each of said first end and said second end are configured to scrape the support surface.

7. The assembly according to claim 6, further comprising a fastener extending through said blade and engaging said mount such that said blade is removably retained on said mount.

8. A scraping assembly configured to scrape a surface thereby facilitating the surface to be smoothed, said assembly comprising:
a handle having a first end, a second end and a bottom side extending between said first end and said second end, said handle being elongated between said first end and said second end;
a pair of grips, each of said grips having an upper side and a lower side, each of said grips being attached to said handle wherein said grips are configured to be gripped, said upper side being positioned to abut said bottom side, one of said grips being positioned adjacent to said first end, one of said grips being positioned between said first end and said second end, said lower side of each of said grips comprising an alternating sequence of hills and valleys, said hills and valleys being distributed along each of said grips wherein said hills and valleys are configured to enhance a grip of each of said grips; and
a scraper being removably attached to said handle, said scraper being positioned on said second end wherein said scraper is configured to be positioned to scrape a support surface, said scraper having a pair of cutting surfaces such that a selected one of said cutting surfaces is exposed on said second end, said scraper comprising:
a mount being attached to and extending away from said second end, said mount having a distal end with respect to said second end, said mount having a top surface and a bottom surface, said top surface curving downwardly to meet said bottom surface at said distal end, said bottom surface having a slot extending toward said top surface,
a blade having a first end and a second end, each of said first end and said second end being sharpened, said blade having a first bend being positioned proximate said first end to define a first portion forming and angle with a central portion, said blade having a second bend being positioned proximate said second end to define a second portion forming an angle with said central portion such that said first portion is congruent with said second portion, said blade being removably attached to said bottom surface having a selected one of said first portion or said second portion extending into said slot such that a selected one of said first portion or said second portion extends downwardly from said bottom surface wherein each of said first end and said second end are configured to scrape the support surface, and
a fastener extending through said blade and engaging said mount such that said blade is removably retained on said mount.
